(19) United States
(12) Patent Application Publication
(10) Pub. No.: US 2011/0151249 A1
(43) Pub. Date: Jun. 23, 2011

(54) PRESSURE-SENSITIVE ADHESIVE TAPE AND METHOD OF MANUFACTURING THE PRESSURE-SENSITIVE ADHESIVE TAPE

(75) Inventors: Eiji Yamanaka, Ibaraki-shi (JP); Tsuyoshi Hiramatsu, Ibaraki-shi (JP); Naoaki Higuchi, Ibaraki-shi (JP)

(73) Assignee: NITTO DENKO CORPORATION, Osaka (JP)

(21) Appl. No.: 12/971,528

(22) Filed: Dec. 17, 2010

(30) Foreign Application Priority Data
Dec. 18, 2009 (JP) 2009-288028

(51) Int. Cl. C09J 7/00; B05D 5/10; B32B 27/30

(52) U.S. Cl. 428/351; 427/208.4

(57) ABSTRACT

A pressure-sensitive adhesive tape is provided with a pressure-sensitive adhesive layer and a water-repellent layer formed on the pressure-sensitive adhesive surface of the pressure-sensitive adhesive layer. The water-repellent layer is formed by using a water repellent exhibiting the water repellency in which a contact angle with water is greater than or equal to 140°. The water-repellent layer may have hydrophobic fine particles. The hydrophobic fine particle may contain a hydrophobic fine silica compound. The hydrophobic fine silica compound may be modified with hexamethyldisilazane.

### CROSS-REFERENCE TO RELATED APPLICATIONS

This application is based upon and claims the benefit of priority from the prior Japanese Patent Application No. 2009-288028, filed on Dec. 18, 2009, the entire contents of which are incorporated herein by reference.

### BACKGROUND OF THE INVENTION

1. Field of the Invention

The present invention relates to a pressure-sensitive adhesive tape.

2. Description of the Related Art

Conventionally, pressure-sensitive adhesive tapes have been used for adhesion between members in many fields. For example, pressure-sensitive adhesive tapes have been used in the casings of large, flat television sets, electrical home appliances, and household equipment, etc., and in the components contained therein. It is preferable that the pressure-sensitive adhesive tapes have high adhesive force from the viewpoint of fixing each component. On the other hand, when the adhesive force is high, it becomes difficult to peel off the pressure-sensitive adhesive tape once attached to a component to correct the position of the component.

Accordingly, a double-faced pressure-sensitive adhesive tape has been devised in which high adhesive force can be exhibited when pressed against an adherend, whereas the adhesiveness thereof hardly appears in the state of being contacted with the adherend such that the positional adjustment can be easily performed during the attachment work (see, for example, Japanese Patent Application Publications Hei10-17827 and Hei11-29749).

However, because a pressure-sensitive adhesive layer whose adhesive force is reduced by an extent is commonly used to easily perform positional adjustment of a pressure-sensitive adhesive tape, there is room for further improvement with respect to the adhesive force when a certain period of time has elapsed since the pressure-sensitive adhesive tape was attached.

### SUMMARY OF THE INVENTION

The present invention has been made in view of these situations, and a purpose of the invention is to provide a pressure-sensitive adhesive tape in which the workability in attaching the pressure-sensitive adhesive tape and the adhesion reliability thereof can be compatible.

In order to solve the aforementioned problem, a pressure-sensitive adhesive tape according to an embodiment of the present invention comprises a pressure-sensitive adhesive layer and a water-repellent layer formed on the pressure-sensitive adhesive surface of the pressure-sensitive adhesive layer. The water-repellent layer is formed by using a water repellent exhibiting the water repellency in which a contact angle with water is greater than or equal to 140°.

According to the embodiment, the adhesive force of the pressure-sensitive adhesive tape, immediately after the pressure-sensitive adhesive surface thereof was attached to an adherend, is reduced to a level in which the pressure-sensitive adhesive tape can be peeled off relatively easily. On the other hand, the adhesive force with the adherend increases as time elapses, thereby exhibiting sufficient adhesive force.

Another embodiment of the present invention is a method of manufacturing a pressure-sensitive adhesive tape. The method comprises preparing a pressure-sensitive adhesive layer and forming a water-repellent layer on the pressure-sensitive adhesive surface of the pressure-sensitive adhesive layer by using a water repellent exhibiting the water repellency in which a contact angle with water is greater than or equal to 140°.

According to the embodiment, a pressure-sensitive adhesive tape can be easily manufactured in which the adhesive force of the pressure-sensitive adhesive tape, immediately after the pressure-sensitive adhesive surface thereof was attached to an adherend, is reduced to a level in which the pressure-sensitive adhesive tape can be peeled off relatively easily, and in which the adhesive force with the adherend increases as time elapses, thereby exhibiting sufficient adhesive force.

### BRIEF DESCRIPTION OF THE DRAWING

Embodiments will now be described, by way of example only, with reference to the accompanying drawing, which are meant to be exemplary, not limiting, in which:

FIG. 1 is a partial sectional view of a pressure-sensitive adhesive tape according to the present embodiment.

### DETAILED DESCRIPTION OF THE INVENTION

The invention will now be described by reference to the preferred embodiments. This does not intend to limit the scope of the present invention, but to exemplify the invention.

Hereinafter, preferred embodiments for carrying out the present invention will be described in detail with reference to the accompanying drawing and table.

Because a pressure-sensitive adhesive tape according to the present embodiment uses materials that are flexible and excellent in durability in the main composition for its pressure-sensitive adhesive layer and support member, the pressure-sensitive adhesive tape can follow a distortion and deformation of an adherend, occurring with a change in temperature, and exhibit strong adhesive force, high durability, and high heat resistance. The pressure-sensitive adhesive tape according to the embodiment is not particularly limited in shape. In the following descriptions, a tape-shaped pressure-sensitive adhesive tape will be described in which a water-repellent layer is formed on the pressure-sensitive adhesive surface on one side of the pressure-sensitive adhesive layer.

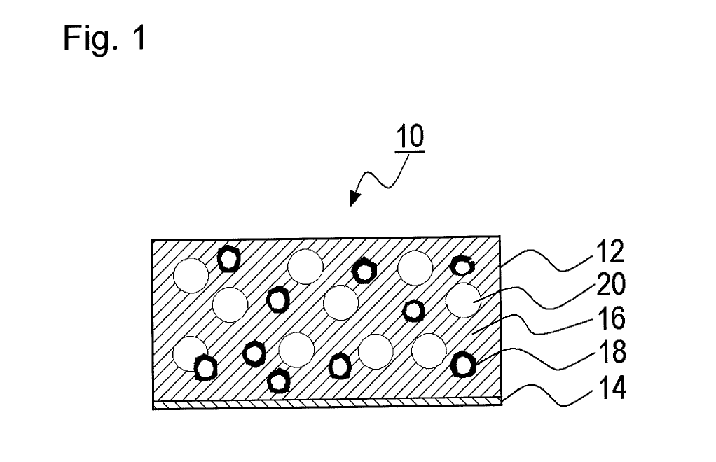

FIG. 1 is a partial sectional view of a pressure-sensitive adhesive tape according to the present embodiment. As illustrated in FIG. 1, a pressure-sensitive adhesive tape 10 comprises a pressure-sensitive adhesive layer 12 and a water-repellent layer 14 formed on the pressure-sensitive adhesive surface on one side of the pressure-sensitive adhesive layer 12. The pressure-sensitive adhesive layer 12 includes an adhesive composition 16, hollow inorganic fine particles 18 contained in the adhesive composition 16, and bubbles 20 formed inside the adhesive composition 16. The water-repellent layer 14 is formed by using a water repellent exhibiting the water repellency in which a contact angle with water is greater than or equal to 140°. In the pressure-sensitive adhesive tape 10 according to the embodiment, the adhesive force thereof occurring immediately after the pressure-sensitive adhesive surface thereof was attached to an adherend is reduced to a level in which the pressure-sensitive adhesive tape 10 can be peeled off relatively easily. On the other hand, the adhesive force with the adherend, of the pressure-sensitive adhesive tape 10, increases as time elapses, thereby exhibiting sufficient adhesive force.

The pressure-sensitive adhesive tape may have a form in which the water-repellent layers are formed on both sides of the pressure-sensitive adhesive tape, other than the form illustrated in FIG. 1 in which the water-repellent layer is formed on only one side thereof. In the case, the pressure-sensitive adhesive layers 12 of which pressure-sensitive adhesive layers consist may or may not be the same type on both sides. Such a pressure-sensitive adhesive tape may be a single separator type in which the pressure-sensitive adhesive surfaces or the water repellent surfaces are protected by only a separator (release liner), or a double separator type in which the pressure-sensitive adhesive surfaces or the water repellant surfaces on both sides are protected by two separators.

In addition, the pressure-sensitive adhesive tape may have a substrate in its inside or on the surface on one side thereof. In this case, the substrate may consist of the same composition as the adhesive composition 16 contained in the pressure-sensitive adhesive layer 12, and may appropriately contain the hollow inorganic fine particles 18 and the bubbles 20. Also, the pressure-sensitive adhesive tape 10 may be formed in a form of being wound in a roll shape, or in a form of sheets being laminated. When the pressure-sensitive adhesive tape 10 is formed in a form of being wound in a roll shape, the formation can be made by, for example, winding the pressure-sensitive adhesive layer 12 in a roll shape in the state where the pressure-sensitive adhesive layer 12 is protected by the separator or a release treatment layer formed on the back side of the substrate.

The pressure-sensitive adhesive tape 10 may have another layer (for example, intermediate layer, subbing layer, etc.) as far as the effects of the present invention are not impaired.

### [Pressure-Sensitive Adhesive Layer]

### (Base Polymer)

The adhesive composition 16 contained in the pressure-sensitive adhesive layer 12 includes a base polymer. The base polymers can be used alone or in combination of two or more thereof. As the base polymer, those used in publicly-known acrylic pressure-sensitive adhesives can be preferably used. An acrylic pressure-sensitive adhesive usually contains, as the base polymer, an acrylic polymer [in particular, an acrylic polymer whose monomer main component is (meth)acrylic acid ester]. In the acrylic polymer, only one type of (meth)acrylic acid ester may be used, or two or more types thereof may be used. As such (meth)acrylic acid ester, (meth)acrylic acid alkyl ester can be used preferably. Examples of (meth)acrylic acid alkyl ester in the acrylic polymer include for example: (meth)acrylic acid C₁₋₂₀ alkyl esters [preferably (meth)acrylic acid C₂₋₁₄ alkyl esters, more preferably (meth)acrylic acid C₂₋₁₀ alkyl esters], such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nonadecyl, and (meth)acrylic acid eicosyl, etc. The (meth)acrylic acid alkyl ester means acrylic acid alkyl ester and/or methacrylic acid alkyl ester and all the “(meta)•••” have the same meaning.

Examples of (meth)acrylic acid esters other than (meth)acrylic acid alkyl esters include, for example: (meth)acrylic acid esters having an alicyclic hydrocarbon group, such as cyclopentyl (meta) acrylate, cyclohexyl (meta) acrylate, and isobornyl (meta) acrylate, etc.; and (meth)acrylic acid esters having an aromatic hydrocarbon group, such as phenyl (meta) acrylate, etc.

Because a (meth)acrylic acid ester is used as the monomer main component of the acrylic polymer, it is preferable that the ratio of the (meth)acrylic acid ester [in particular, (meth)acrylic acid alkyl ester] to the total mass of the monomer components for preparing the acrylic polymer is, for example, 60 mass % or more (preferably 80 mass % or more). Thereby, it is unnecessary to separately perform an adhesion treatment to use as an adhesive, and hence an adhesive can be produced in a relatively simple and easy way, allowing the production efficiency to be improved.

In the aforementioned acrylic polymer, various copolymeric monomers, such as polar group-containing monomer and polyfunctional monomer, may be used as monomer components. By using a copolymeric monomer as a monomer component, for example, the adhesive force to an adherend can be improved or the cohesive force of an adhesive (pressure-sensitive adhesive layer) can be enhanced. Copolymeric monomers can be used alone or in combination of two or more thereof.

Examples of the aforementioned polar group-containing monomers include, for example: carboxyl group-containing monomers, such as (meth)acrylic acid, itaconic acid, maleic acid, fumaric acid, crotonic acid, and isocrotonic acid, or anhydrides thereof (maleic anhydride, etc.); hydroxyl group-containing monomers, such as (meth)acrylic acid hydroxyalkyls including (meth)acrylic acid hydroxyethyl, (meth)acrylic acid hydroxypropyl, and (meth)acrylic acid hydroxybutyl, etc.; amide group-containing monomers, such as acrylamide, methacrylamide, N,N-dimethyl(meth)acrylamide, N-methylol(meth)acrylamide, N-methoxymethyl(meth)acrylamide, and N-butoxymethyl(meth)acrylamide, etc.; amino group-containing monomers, such as (meth)acrylic acid aminoethyl, (meth)acrylic acid dimethylaminoethyl, and (meth)acrylic acid t-butylaminoethyl, etc.; glycidyl group-containing monomers, such as (meth)acrylic acid glycidyl and (meth)acrylic acid methylglycidyl, etc.; cyano group-containing monomers, such as acrylonitrile and methacrylonitrile, etc.; and heterocycle-containing vinyl monomers, such as N-vinylpyridine, N-vinylpiperidone, N-vinylpyrimidine, N-vinylpiperazine, N-vinylpyrazine, N-vinylpyrrole, N-vinylimidazole, and N-vinyloxazole, etc., as well as N-vinyl-2-pyrrolidone and (meth)acryloyl morpholine. As the polar group-containing monomer, carboxyl group-containing monomers, such as acrylic acid, etc., or anhydrides thereof are preferred.

The use amount of the polar group-containing monomer is smaller than or equal to 30 mass % (for example, 1 to 30 mass %) based on the total mass of the monomer components for preparing the acrylic polymer, and is preferably 3 to 20 mass %. If the use amount of the polar group-containing monomer exceeds 30 mass % based on the total mass the monomer components for preparing the acrylic polymer, for example, the cohesive force of the acrylic pressure-sensitive adhesive becomes too high, and accordingly there is the fear that the pressure-sensitive adhesiveness may be deteriorated. On the other hand, if the use amount thereof is too small (for example, below one mass % based on the total mass of the monomer components for preparing the acrylic monomer), for example, the cohesive force of the acrylic pressure-sensitive adhesive is decreased, and accordingly high shear force cannot be obtained. A polyfunctional monomer can also be used to adjust the cohesive force of the acrylic pressure-sensitive adhesive.

Examples of the aforementioned polyfunctional monomers include, for example: hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylol methane tri(meth)acrylate, allyl(meth)acrylate, vinyl(meth)acrylate, divinylbenzene, epoxy acrylate, polyester acrylate, urethane acrylate, butyl di(meth)acrylate, hexyl di(meth)acrylate, etc.

The use amount of the polyfunctional monomer is smaller than or equal to two mass % (for example, 0.01 to 2 mass %) based on the total mass of the monomer components for preparing the acrylic polymer, and is preferably 0.02 to 1 mass %. If the use amount of the polyfunctional monomer exceeds two mass % based on the total mass of the monomer components for preparing the acrylic polymer, for example, the cohesive force of the acrylic pressure-sensitive adhesive becomes too high, and hence there is the fear that the pressure-sensitive adhesiveness may be deteriorated. On the other hand, if the use amount of the polyfunctional monomer is too small (for example, below 0.01% based on the total mass of the monomer components for preparing the acrylic polymer), for example, there is the fear that the cohesive force of the acrylic pressure-sensitive adhesive may be decreased.

Examples of the copolymeric monomers other than the polar group-containing monomers or polyfunctional monomers include: for example: vinyl esters, such as vinyl acetate and vinyl propionate, etc.; aromatic vinyl compounds, such as styrene and vinyl toluene, etc.; olefins or dienes, such as ethylene, butadiene, isoprene and isobutylene, etc.; vinyl ethers, such as vinyl alkyl ether, etc.; vinyl chloride; (meth)acrylic acid alkoxy alkyl monomers, such as (meth)acrylic acid methoxyethyl, (meth)acrylic acid ethoxyethyl, etc.; sulfonate group-containing monomers, such as vinyl sulfonate sodium, etc.; phosphate group-containing monomers, such as 2-hydroxyethyl acryloyl phosphate, etc.; imide group-containing monomers, such as cyclohexyl maleimide and isopropylmaleimide, etc.; isocyanate group-containing monomers, such as 2-methacryloyloxyethyl isocyanate, etc.; fluorine atom-containing (meth)acrylate; and silicon atom-containing (meth)acrylate, etc.

### (Polymerization Initiator)

The aforementioned acrylic polymer can be prepared by a publicly-known or commonly-used polymerization method. Examples of the polymerization method include, for example, a solution polymerization method, emulsion polymerization method, bulk polymerization method, and photopolymerization method, etc. In manufacturing the pressure-sensitive adhesive layer 12 according to the present embodiment, when the acrylic polymer is to be prepared as a base polymer, it is preferable to utilize a curing reaction by heat or an activated energy ray, in which a polymerization initiator, such as a thermal polymerization initiator or photopolymerization initiator (photoinitiator), is used, in terms of workability and obtaining a stable bubble structure. That is, the adhesive composition 16 according to the embodiment contains a polymerization initiator, such as a thermal polymerization initiator or photopolymerization initiator, etc.

When containing a polymerization initiator (thermal polymerization initiator or photopolymerization initiator, etc.), as stated above, the adhesive composition 16 can be cured by heat or an activated energy ray. Accordingly, because the adhesive component 16 is cured in the state where the hollow inorganic fine particles 18 are mixed, the pressure-sensitive adhesive layer 12 can be easily formed in which the hollow inorganic fine particles 18 are stably contained.

As such a polymerization initiator, a photopolymerization initiator can be preferably used in terms of the advantage that a polymerization period can be shortened, etc. That is, it is preferable that the pressure-sensitive adhesive layer 12 is formed so as to stably contain the hollow inorganic fine particles 18 and bubbles 20 by utilizing polymerization with the use of an activated energy ray. The polymerization initiators can be used alone or in combination of two or more thereof.

Such a photopolymerization initiator is not particularly limited, but, for example, a benzoin ether photopolymerization initiator, acetophenone photopolymerization initiator, α-ketol photopolymerization initiator, aromatic sulfonyl chloride photopolymerization initiator, photoactive oxime photopolymerization initiator, benzoin photopolymerization initiator, benzyl photopolymerization initiator, benzophenone photopolymerization initiator, ketal photopolymerization initiator, or thioxanthone photopolymerization initiator, etc., can be used.

Specific examples of the benzoin ether photopolymerization initiator include, for example: benzoin methyl ether, benzoin ethyl ether, benzoin propyl ether, benzoin isopropyl ether, benzoin isobutyl ether, 2,2-dimethoxy-1,2-diphenylethane-1-one, and anisole methyl ether, etc. Specific examples of the acetophenone photopolymerization initiator include, for example: 2,2-diethoxyacetophenone, 2,2-dimethoxy-2-phenylacetophenone, 1-hydroxycyclohexyl phenyl ketone, 4-phenoxy dichloroacetophenone, and 4-t-butyl-dichloroacetophenone, etc. Specific examples of the α-ketol photopolymerization initiator include, for example: 2-methyl-2-hydroxy propiophenone and 1-[4-(2-hydroxyethyl)-phenyl]-2-hydroxy-2-methylpropane-1-one, etc. Specific examples of the aromatic sulfonyl chloride photopolymerization initiator include, for example, 2-naphthalene sulfonyl chloride, etc. Specific examples of the photoactive oxime photopolymerization initiator include, for example, 1-phenyl-1,1-propanedione-2-(o-ethoxycarbonyl)-oxime, etc.

Specific examples of the benzoin photopolymerization initiator include, for example, benzoin, etc. Specific examples of the benzyl photopolymerization initiator include, for example, benzyl, etc. Specific examples of the benzophenone photopolymerization initiators include, for example, benzophenone, benzoylbenzoic acid, 3,3′-dimethyl-4-methoxybenzophenone, polyvinyl benzophenone, and α-hydroxy cyclohexyl phenyl ketone, etc. Specific examples of the ketal photopolymerization initiator include, for example, benzyldimethyl ketal, etc. Specific examples of the thioxanthone photopolymerization initiator include, for example, thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, 2,4-diisopropyl thioxanthone, and dodecyl thioxanthone, etc.

The use amount of the photopolymerization initiator is not particularly limited as far as the acrylic polymer can be formed by photopolymerization, but can be selected from a range of, for example, 0.01 to 5 parts by mass (preferably 0.03 to 3 parts by mass) based on 100 parts by mass of the whole monomer components for forming the base polymer in the adhesive composition 16 [in particular, the whole monomer components for forming the acrylic polymer whose monomer main component is (meth) acrylic acid ester].

In activating the photopolymerization initiator, it is important to radiate an activated energy ray to the adhesive composition 16. Examples of such an activated energy ray include, for example: ionizing radiations, such as an α-ray, β-ray, γ-ray, neutron ray, and electron beam, etc.; and an ultraviolet ray, etc., and among them, an ultraviolet ray is particularly preferred. Radiation energy of an activated energy ray and a radiation period thereof, etc., are not particularly limited, and they only have to activate the photopolymerization initiator to generate a reaction of the monomer components. As stated above, by polymerized with an action by the activated energy ray, quick and uniform polymerization can be performed, thereby allowing the production efficiency to be improved.

Examples of the thermal polymerization initiator include, for example: azo polymerization initiators [for example, 2,2′-azobisisobutyronitrile, 2,2′-azobis-2-methylbutyronitrile, 2,2′-azobis(2-methylpropionic acid)dimethyl, 4,4′-azobis-4-cyanovalerianic acid, azobis isovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, and 2,2′-azobis (N,N′-dimethyleneisobutylamidine)dihydrochloride, etc.]; peroxide polymerization initiators (for example, dibenzoyl peroxide, and tert-butyl permaleate, etc.); and redox polymerization initiator, etc. The use amount of the thermal polymerization initiator is not particularly limited, and only has to be within a conventional range in which it can be used as a thermal polymerization initiator.

As stated above, because the pressure-sensitive adhesive layer 12 is stably cured, by various polymerizations, in the state where the hollow inorganic fine particles 18 are scattered, thereby allowing the cohesive force and heat resistance to be improved.

### (Hollow Inorganic Fine Particles)

As a result of the intensive study by the present inventors, it has been learned that the pressure-sensitive adhesive layer 12 containing the hollow inorganic fine particles 18 and the pressure-sensitive adhesive tape 10 provided with such the pressure-sensitive adhesive layer 12 have high shear strength without impairing the usual adhesive force.

A method of containing the hollow inorganic fine particles 18 into the adhesive composition 16 is not particularly limited, but a method can be cited in which, for example, after the adhesive composition 16 of which the pressure-sensitive adhesive layer 12 consist has been formed, the hollow inorganic fine particles 18 are combined and mixed into the adhesive composition 16. Alternatively, as another method, a method can be cited in which the hollow inorganic fine particles 18 are combined and mixed into a mixture of acrylic monomers of which the acrylic polymer is formed or into a partial polymer in which part of the acrylic monomers has been polymerized. Of these methods, the latter method is preferred in terms of the workability.

Examples of the fine particles contained in the pressure-sensitive adhesive layer 12 according to the present embodiment include, for example: carbide particles, such as silicon carbide, boron carbide, and carbon nitride, etc.; nitride particles, such as aluminum nitride, silicon nitride, and boron nitride, etc.; ceramic particles represented by oxides, such as alumina and zirconium; and inorganic fine particles, such as calcium carbide, aluminum hydroxide, glass, silica, and hydrophobic silica, etc. In particular, examples of the hollow inorganic fine particles 18 include: hollow balloons made of glass, such as hollow glass balloons, etc.; hollow balloons made of compounds, such as hollow aluminum balloons; and hollow ceramic balloons, etc.

Among these fine particles, it is preferable to use hollow inorganic fine particles in terms of the efficiency in the polymerization when an ultraviolet reaction is used, and the weight of the fine particles. It is more preferable to use the hollow glass balloons, because the adhesive force at high temperature can be improved without impairing the strength and properties necessary for the pressure-sensitive adhesive layers 12, such as the shear strength and holding force, etc.

The average particle size of the hollow inorganic fine particles 18 is not particularly limited, but may be selected in accordance with a desired property required for the pressure-sensitive adhesive layer 12. For example, the average particle size of the hollow inorganic fine particles 18 may be within a range of 1 to 500 μm, preferably within a range of 5 to 200 μm, more preferably 20 to 80 μm, and still more preferably 30 to 50 μm. Thereby, the surface area of the hollow inorganic fine particles 18 per unit mass of the pressure-sensitive adhesive layer 12 can be made large without impairing the properties of the pressure-sensitive adhesive layer 12, such as the shear strength and holding force.

The specific gravity of the hollow inorganic fine particles 18 is not particularly limited, but may be selected in accordance with a desired property required for the pressure-sensitive adhesive layer 12. For example, the specific gravity thereof may be within a range of 0.1 to 0.8 g/cm³, and preferably within a range of 0.15 to 0.50 g/cm³. Thereby, the surface area of the hollow inorganic fine particles 18 per unit mass of the pressure-sensitive adhesive layer 12 can be made large without impairing the properties of the pressure-sensitive adhesive layer 12, such as the shear strength and the holding force. When the specific gravity thereof is larger than 0.1 g/cm³, and more preferably larger than 0.15 g/cm³, floating of the hollow inorganic fine particles 18 can be reduced when the hollow inorganic fine particles 18 is combined and mixed into a mixture of the acrylic monomers or into a partial polymer in which part of the acrylic monomer has been polymerized. Accordingly, the hollow inorganic fine particles 18 can be uniformly scattered in the pressure-sensitive adhesive layer 12. Further, when the specific gravity thereof is greater than or equal to the aforementioned lower limit, the glass strength is secured to some extent, thereby reducing cracking of the hollow inorganic fine particles 18 themselves.

On the other hand, when the specific gravity of the hollow inorganic fine particles 18 is smaller than 0.8 g/cm³, and more preferably smaller than 0.50 g/cm³, the transmission rate of an ultraviolet ray is secured to some extent, and hence a decrease in the efficiency of an ultraviolet reaction can be reduced. Further, because a cheaper material can be used, the production cost can be reduced to a lower level. Still further, because an increase in the weight of the pressure-sensitive adhesive layer 12 in which the hollow inorganic fine particles 18 are scattered is reduced, the workability during the production and use of the pressure-sensitive adhesive layer 12 can be improved, thereby also contributing to a reduction in weight of the apparatus using the pressure-sensitive adhesive tape.

The surface of the hollow inorganic fine particles 18 may be subjected to various surface treatments (for example, low surface tension treatment by silicone compound or fluorine compound, etc.).

It is better that the use amount of the hollow inorganic fine particles 18 is one part by mass or more based on 100 parts by mass of the whole monomer components for forming an acrylic polymer that is the base polymer of the adhesive composition 16, and preferably five parts by mass or more. By scattering the hollow inorganic fine particles 18 into the adhesive composition 16 at a ratio greater than or equal to the aforementioned range, the total of the surface areas of the contained hollow inorganic fine particles 18 can be increased and it becomes easy to finely scatter the bubbles.

On the other hand, it is better that the use amount of the hollow inorganic fine particles 18 is fifteen parts by mass or less based on 100 parts by mass of the whole monomer components for forming the acrylic polymer, preferably thirteen parts by mass or less, and more preferably ten parts by mass or less. By scattering the hollow inorganic fine particles 18 into the adhesive composition 16 at a ratio smaller than or equal to the aforementioned range, the concavities and convexities created between the pressure-sensitive adhesive layer 12 and the adherend are decreased when the pressure-sensitive adhesive layer 12 is used in the pressure-sensitive adhesive tape 10, thereby reducing a decrease in the adhesive force, occurring due to a decrease in the adhesion area.

Examples of the hollow glass balloons used as the hollow inorganic fine particles 18 include “Fuji Balloon H-35” and “Fuji Balloon H-40” (both are made by FUJI SILYSIA CHEMICAL LTD.), etc.

### (Bubbles)

The pressure-sensitive adhesive layer 12 according to the present embodiment appropriately contains the bubbles 20. Thereby, the pressure-sensitive adhesive layer 12 can exhibit sufficient adhesiveness to a curved surface and a concave-convex surface and also exhibit sufficient resistance to resilience. The amount of the bubbles 20 able to be mixed into the pressure-sensitive adhesive layer 12 is not particularly limited, but is appropriately selected in accordance with a use application, etc. It is better that the bubbles 20 according to the embodiment is contained in an amount within a range of 5 to 40% by volume based on the whole volume of the pressure-sensitive adhesive layer 12, and preferably within a range of 8 to 30% by volume. When the bubbles 20 are contained in an amount greater than or equal to 5% by volume, the pressure-sensitive adhesive layer 12 can exhibit the aforementioned properties more surely. Further, by making the amount of the contained bubbles 20 smaller than or equal to 40% by volume based on the whole volume of the pressure-sensitive adhesive layer 12, the presence of the bubbles penetrating through the pressure-sensitive adhesive layer 12 from the front surface to the back surface thereof is reduced, and thereby reducing the deterioration of the adhesive performance and appearance of the pressure-sensitive adhesive layer 12.

It is desirable that the bubbles 20 mixed in the pressure-sensitive adhesive layer 12 are basically closed-cell type bubbles, but closed-cell type bubbles and interconnected-cell type bubbles may coexist.

Also, the bubbles 20 usually have a spherical shape (in particular, a true spherical shape), but may have a distorted spherical shape. The average bubble size of the bubbles 20 is not particularly limited, but is selected from a range of, for example, 1 to 1000 μm (preferably 10 to 500 μm, and more preferably 30 to 300 μm). The average bubble size (diameter) of the bubbles can be measured from an image of the cross section of a tape sample, the image being obtained with an electron microscope, etc.

A gas component contained in the bubble (gas component of which the bubble is formed; sometimes referred to as a “bubble-forming gas”) is not particularly limited, but various gas components, such as inactive gases including nitrogen, carbon dioxide, and argon, etc., and air, etc. When a bubble-forming gas is mixed with the adhesive composition 16 and then a polymerization reaction, etc. is performed, it is preferable that the bubble-forming gas does not hamper the reaction. Nitrogen is preferred as a bubble-forming gas in terms of not hampering the reaction and cost.

### (Surfactant)

The pressure-sensitive adhesive layer 12 and the adhesive composition 16 of which the pressure-sensitive adhesive layer 12 consists may appropriately include various additives in accordance with the application of the pressure-sensitive adhesive tape 10 including them. For example, a surfactant is appropriately added in the pressure-sensitive adhesive layer 12 and the adhesive composition 16 according to the present embodiment, in terms of: the adhesiveness between the hollow inorganic fine particles 18 and the base polymer; reduction in the frictional resistance; and the mixability and stability of the bubbles.

Examples of such a surfactant include, for example: an ionic surfactant, hydrocarbon surfactant, silicon surfactant, and fluorochemical surfactant, etc. Among them, a fluorochemical surfactant is preferred, and in particular, the fluorochemical surfactant having an oxy C₂₋₃ alkylene group and a fluorinated hydrocarbon group in its molecule is preferred. The fluorochemical surfactants may be used alone or in combination of two or more thereof. As such a fluorochemical surfactant, for example, a surfactant with a product name of “Surflon S-393” (made by AGC SEIMI CHEMICAL CO., LTD) is preferred.

The use amount (solid content) of a fluorochemical surfactant is not particularly limited, but can be selected from, for example, a range of 0.01 to 2 parts by mass (preferably 0.03 to 1.5 parts by mass, and more preferably 0.05 to 1 parts by mass) based on 100 parts by mass of the whole monomer components for forming the base polymer in the adhesive composition 16 [in particular, the whole monomer components for forming an acrylic polymer whose monomer main component is (meth)acrylic acid ester]. If the use amount of a fluorochemical surfactant is below 0.01 parts by mass based on 100 parts by mass of the base polymer in the adhesive composition 16 containing the bubbles 20, the mixability of the bubbles 20 is decreased and it becomes difficult to mix a sufficient amount of the bubbles 20 into the adhesive composition 16. On the other hand, if the use amount of a fluorochemical surfactant exceeds 2 parts by mass based on 100 parts by mass of the base polymer containing the bubbles 20, the adhesive performance is deteriorated.

In the present embodiment, it is preferable that the bubbles 20 are combined and mixed into the adhesive composition 16 as the final component to be combined, in order for the bubbles 20 to be stably mixed into and present in the pressure-sensitive adhesive layer 12. In particular, the viscosity of the adhesive composition 16 prior to the mixture of the bubbles 20 is not particularly limited, as far as the mixed bubbles 20 are stably held, but a viscosity of 5 to 50 Pa·s (preferably 10 to 40 Pa·s) is preferred, the viscosity being measured by using a BH viscometer as a viscometer and at the conditions where a rotor is a No. 5 rotor, the number of rotations is 10 rpm, and measuring temperature is 30° C. If the viscosity (BH viscometer, No. 5 rotor, 10 rpm, 30° C.) of the adhesive composition 16 into which the bubbles 20 are mixed is below 5 Pa·s, the mixed bubbles are instantly integrated together and sometimes released outside the system, because the viscosity is too low. On the other hand, if the viscosity exceeds 50 Pa·s, it becomes difficult to form the pressure-sensitive adhesive layer 12 containing the bubbles 20.

The viscosity of the acrylic monomer mixture prior to mixing the bubbles can be adjusted by, for example: a method of combining various polymer components, such as acrylic rubber, and thickening additive, etc.; and a method of partially polymerizing a monomer component for forming the base polymer [for example, a monomer component for forming an acrylic polymer, such as (meth)acrylic acid ester, etc.], etc.

Specifically, a monomer mixture is prepared by mixing, for example, a monomer component for forming the base polymer [for example, a monomer component for forming an acrylic polymer, such as (meth)acrylic acid ester, etc.] and a polymerization initiator (for example, a photopolymerization initiator, etc.). And then, the monomer mixture is subjected to a polymerization reaction in accordance with the type of the polymerization initiator, so that a composition (syrup) is prepared in which part of the monomer component is only polymerized. Thereafter, a fluorochemical surfactant and the hollow inorganic fine particles 18, and various additives if necessary, are combined into the syrup. Thereby, a precursor of the adhesive composition 16 having a proper viscosity with which bubbles can be stably contained, can be prepared. By introducing and mixing bubbles into the precursor of the adhesive composition 16, the pressure-sensitive adhesive layer 12 can be obtained in which the bubbles 20 are uniformly scattered.

A method of mixing bubbles is not particularly limited, but a publicly-known bubble mixing method can be used. For example, an example of such an apparatus is provided with: a stator having many fine teeth placed on a disk with a through-hole at its center; and a rotor having teeth as fine as those of the stator, which is placed on the disk to face the stator. The adhesive composition 16 containing bubbles is introduced between the teeth on the stator and that on the rotor in the apparatus, and while rotating the rotor at high speed, a gas component for forming bubbles (bubble-forming gas) is introduced into the precursor of the adhesive composition 16 through the through-hole. Thereby, the adhesive composition 16 can be obtained in which the bubbles are finely scattered and mixed.

In order to reduce or prevent the integration of the bubbles, it is preferable that the processes from the mixture of the bubbles to the formation of the pressure-sensitive adhesive layer 12 containing the bubbles are continuously performed as a series of processes. That is, the pressure-sensitive adhesive layer 12 is obtained as follows: the adhesive composition 16 containing bubbles is first prepared by mixing the bubbles as stated above; and subsequently the pressure-sensitive adhesive layer 12 is obtained by using the adhesive composition 16 containing the bubbles with a publicly-known formation method. Specifically, the pressure-sensitive adhesive layer 12 containing bubbles is formed by, for example, coating the adhesive composition 16 containing the bubbles on a predetermined surface, and then by drying or curing the adhesive composition 16 if necessary. In forming the pressure-sensitive adhesive layer 12 containing the bubbles 20, it is preferable to cure the adhesive composition 16 by radiating a heat ray or an activated energy ray as stated above.

In the adhesive composition 16 containing the aforementioned bubbles, the integration of the bubbles hardly occurs and a sufficient amount of the bubbles are stably held therein, and hence the adhesive composition 16 can be preferably used as a material for forming the pressure-sensitive adhesive layer 12 in the pressure-sensitive adhesive tape 10 by appropriately selecting a base polymer and an additive of which the adhesive composition 16 consists. Also, the adhesive composition 16 containing the aforementioned bubbles can be preferably used as a material for forming a substrate (in particular, the substrate containing bubbles to be used in a pressure-sensitive adhesive member) by appropriately selecting a base polymer and an additive of which the adhesive composition 16 consists.

### (Other Additives)

The pressure-sensitive adhesive layer 12 according to the present embodiment may contain an appropriate additive other than the base polymer, polymerization initiator, hollow inorganic fine particles, and surfactant, in accordance with an application of the pressure-sensitive adhesive layer 12. For example, when the pressure-sensitive adhesive layer 12 is used in the pressure-sensitive adhesive tape 10, appropriate additives, such as cross-linking agent (for example, polyisocyanate cross-linking agent, silicone cross-linking agent, epoxy cross-linking agent, and alkyl-etherified melamine cross-linking agent, etc.), tackifier (solid, semisolid, and liquid tackifier at normal temperature consisting of, for example, rosin derivative resin, polyterpene resin, petroleum resin, and oil soluble phenol resin, etc.), plasticizer, filler other than the aforementioned hollow inorganic fine particle, anti-aging agent, antioxidant, and colorant (pigment and dye, etc.), etc., may be contained in the pressure-sensitive adhesive layer 12.

For example, when forming the pressure-sensitive adhesive layer 12 using a photopolymerization initiator, a pigment (color pigment) for coloring the pressure-sensitive adhesive layer 12 can be used in an amount that does not hamper a photopolymerization. When black is desired as the color of the pressure-sensitive adhesive layer 12, for example, carbon black can be used. The use amount of carbon black is preferably smaller than or equal to, for example, 0.15 parts by mass (for example, 0.001 to 0.15 parts by mass) based on 100 parts by mass of the whole monomer components for forming the base polymer in the adhesive composition 16 [in particular, the whole monomers for forming an acrylic polymer whose monomer main component is (meth) acrylic acid ester], in terms of a coloring degree and not hampering a photopolymerization reaction, and is more preferably selected from a range of 0.01 to 0.1 parts by mass.

The aforementioned pressure-sensitive adhesive layer 12 may have either form of a single layer and laminated layers. The thickness of the pressure-sensitive adhesive layer 12 is not particularly limited, but can be selected from a range of, for example, 200 to 5000 μm (preferably 300 to 4000 and more preferably 400 to 3000 μm). If the thickness thereof is smaller than 200 μm, the cushion performance is deteriorated, thereby deteriorating the adhesiveness to a curved surface and a concave-convex surface. On the other hand, if the thickness thereof is larger than 5000 μm, it becomes difficult to obtain a layer with a uniform thickness.

### [Water-Repellent Layer]

As a result of intensive study to make the workability in attaching pressure-sensitive adhesive tapes and the adhesion reliability thereof compatible, the present inventor has reached the idea of a water-repellent layer being formed on the surface of a pressure-sensitive adhesive layer. Also, the inventor has reached the idea that a hydrophobic coating film-forming composition that is made by combining a hydrophobic fine silica compound modified with hexamethyldisilazane, a resin compound, and a volatile solvent can be one of the water repellants preferably used in forming a water-repellant film. And, the inventor has found that, by coating such a water repellant on the surface of the pressure-sensitive adhesive layer, the peel-off adhesive force of a pressure-sensitive adhesive tape, occurring immediately after the pressure-sensitive adhesive tape was attached to an adherend, can be reduced. In particular, the water repellant exhibiting the water repellency in which a contact angle with water is greater than or equal to 140° is preferred. The water repellent in which the contact angle is greater than or equal to 150° is more preferred, and the water repellant in which the contact angle is greater than or equal to 160° is still more preferred. The contact angle used herein can be measured by, for example, the following method.

Production of samples to be measured: a water repellant is coated on one surface of a polyethylene terephthalate film: “Lumirror S10#38” having a thickness of 38 mm (coating amount of 5 ml) by using Meyer Bar, and a coated polyethylene terephthalate film that has been dried for five minutes or longer at normal temperature is prepared as a sample for contact angle measurement.

Measurement: a certain amount of distilled water droplet is made to fall in drop on the surface of the water repellent by using FACE CA-X model made by Kyowa Interface Science Co., LTD., so that the angle between the droplet and the water-repellent surface is measured.

One of the water repellents preferably used in the present embodiment will be first described. The water repellent according to the embodiment is a hydrophobic coating film-forming composition containing hydrophobic fine particles, a resin compound, and a volatile solvent.

A hydrophobic fine silica compound, as the hydrophobic fine particles contained in the hydrophobic coating film-forming composition, is modified by a contact reaction of hexamethyldisilazane with OH groups on the surface of the fine silica. It is preferable that the average particle size of the initial particles of such a hydrophobic fine silica compound is within a range of 5 to 50 nm. If the average particle size is below 5 nm, there is a trend in which the formability of the hydrophobic coating film, which is created after the hydrophobic coating film-forming composition has been coated and dried, is deteriorated. Accordingly, the hydrophobic fine silica compound is likely to be scattered from the coating film, resulting in the trend of the hydrophobicity being decreased. On the other hand, if the average particle size exceeds 50 nm, it becomes difficult to form a uniform hydrophobic coating film, resulting in the trend of the hydrophobicity being decreased.

A carbon amount in such a hydrophobic fine silica compound is preferably within a range of 2 to 5 mass %, and in particular, preferably within a range of 2.2 to 4 mass %. If the carbon amount is below two mass %, there is a trend in which modification of the fine silica surface toward hydrophobicity may become insufficient. On the other hand, if the carbon amount exceeds five mass %, non-uniformly modified portions are likely to occur, resulting in the trend of good hydrophobicity being hampered.

In addition, it is preferable that, in modifying the hydrophobic fine silica by contact reaction of hexamethyldisilazane, the hydrophobic fine silica is first modified by contact reaction of alkyl halogeno silane, such as methyltrichlorosilane and dimethyldichlorosilane, etc., with OH groups on the surface of the fine silica, and then by contact reaction of hexamethyldisilazane. Methods of manufacturing such a hydrophobic fine silica compound are disclosed in, for example, Japanese Patent Nos. 2886037 and 2886105, etc. Alternatively, hydrophobic fine silica compounds are commercially available and examples thereof include, for example, Reolosil HM-20L and Reolosil HM-30S (made by TOKUYAMA Corp.) modified by contact reaction of hexamethyldisilazane with OH groups on the surface of fine silica, and Reolosil ZD-30ST (made by TOKUYAMA Corp.) modified by contact reaction of alkyl halogeno silane with OH groups on the surface of fine silica, and then by contact reaction of hexamethyldisilazane, etc.

The resin compound contained in the hydrophobic coating film-forming composition functions as a binder for supporting the hydrophobic fine silica compound relative to the surface of a member to be treated. Such a resin compound is not particularly limited, but, for example, an acrylic resin, vinyl acetate resin, polyurethane resin, epoxy resin, alicyclic saturated hydrocarbon resin, rosin ester resin, alkyl phenol resin (novolac type), alkyl phenol resin (resol type), terpene phenol resin, etc. can be used. Among them, an acrylic resin, polyurethane resin, alicyclic saturated hydrocarbon resin, and rosin ester resin are preferably used. As such an acrylic resin, in particular, an acrylic copolymer emulsion having an acid acrylic copolymer whose viscosity at a solid content of 30 mass % is smaller than or equal to 100 mPa·s (measured with a B-type viscometer), is preferably used. In addition, as a polyurethane resin, in particular, an ester polyurethane resin emulsion is preferably used. Further, the alicyclic saturated hydrocarbon resin whose softening temperature is higher than or equal to 80° C. is particularly preferred, and the rosin ester resin whose softening temperature is higher than or equal to 90° C. is particularly preferred. By using an acrylic resin as stated above, there is a tendency in which the durability for keeping the hydrophobicity in the resultant coating film and the adhesiveness to the substrate are further increased. Also, by using a polyurethane resin, alicyclic saturated hydrocarbon resin, or rosin ester resin, there is a tendency in which the force for supporting the hydrophobic fine silica compound is further increased. Also, when an alicyclic saturated hydrocarbon resin or rosin ester resin is used, there is a tendency in which the hydrophobicity (water repellency) is particularly improved. Such an acrylic resin, polyurethane resin, alicyclic saturated hydro carbon resin, and rosin ester resin are commercially available, and examples thereof include, for example, Rikabond FK-610 (made by CSC co., ltd.) that is an acrylic copolymer emulsion, NEOSTECKER 1200 (made by NICCA CHEMICAL CO., LTD) that is an ester polyurethane resin emulsion, Alcon P-90 (made by ARAKAWA CHEMICAL INDUSTRIES, LTD.) that is an alicyclic saturated hydrocarbon resin, and Super Ester A-100 (made by ARAKAWA CHEMICAL INDUSTRIES, LTD.) that is a rosin ester resin, etc.

The volatile solvent contained in the hydrophobic coating film-forming composition functions as a scattering medium for scattering the hydrophobic fine silica compound and the resin compound. Such a volatile solvent is not particularly limited, but may be a single organic solvent or a mixture of two or more thereof. Also, these organic solvents may contain water.

It is preferable that an organic solvent used as the volatile solvent is substantially inactive. Examples of a preferred organic solvent include, for example: C₁ to C₄ aliphatic alcohols, such as methanol, ethanol, isopropyl alcohol, isobutyl alcohol, etc.; ketones, such as acetone and ethyl methyl ketone, etc.; esters, such as ethyl acetate, etc.; ethers, such as diethyl ether, diisopropyl ether, and methyl t-butyl ether, etc.; aliphatic hydrocarbons; alicyclic hydrocarbons; and aromatic hydrocarbons, etc.

In the hydrophobic coating film-forming composition, it is preferable that the content of the hydrophobic fine silica compound is increased in terms of further improving the hydrophobicity, and that the content of the resin compound is increased in terms of further improving the durability (adhesiveness). Accordingly, there is a tendency in which a coating film provided with good hydrophobicity and durability can be obtained by making both the two properties compatible. The relative amounts of these components are preferably determined such that the combination ratio (based on mass) of the hydrophobic fine silica compound to the resin compound is within a range of 50:50 to 99:1. In particular, when an acrylic resin or a polyurethane resin is used as the resin compound, both the two compounds are preferably combined such that the combination ratio (based on mass) of the hydrophobic fine silica compound to the resin compound is within a range of 80:20 to 99:1. Alternatively, when an alicyclic saturated hydrocarbon resin or rosin ester resin is used as the resin compound, both the compounds are more preferably combined such that the combination ratio (based on mass) of the hydrophobic fine silica compound to the resin compound is within a range of 50:50 to 95:5. By combining the two compounds at such a combination ratio, there is a tendency in which better hydrophobicity and durability (adhesiveness) can be achieved. If the two compounds are combined such that the combination ratio (based on mass) of the hydrophobic fine silica compound to the resin compound is below 50:50, that is, the resin compound is combined at a ratio exceeding 50 mass %, there is the tendency of the hydrophobicity being decreased. On the other hand, if the two are combined such that the combination ratio (based on mass) of the hydrophobic fine silica compound to the resin compound exceeds 99:1, that is, the hydrophobic fine silica compound is combined at a ratio exceeding 99 mass %, there is a tendency in which the hydrophobic fine silica compound is likely to drop out of the hydrophobic coating film.

A combination amount of the volatile solvent in the hydrophobic coating film-forming composition according to the present embodiment is not particularly limited, and is appropriately selected in accordance with the adopted coating method; however, it is generally preferable that the volatile solvent is combined in an amount in which the content of a non-volatile component (solid component) in the resultant hydrophobic coating film-forming composition is within a range of approximately 0.1 to 6 mass %.

In the present embodiment, the hydrophobic fine silica compound, resin compound, and volatile solvent can be mixed together to make the hydrophobic coating film-forming composition just before the composition is used; however, when the scattering property of the hydrophobic fine silica compound and the resin compound is too small, the scattering stability in the hydrophobic coating film-forming composition becomes deteriorated over time, and hence aggregated particles, occurring due to deterioration of scattering, becomes to exist in the hydrophobic coating film, thereby resulting in the trend of the hydrophobicity and durability (adhesiveness) being decreased. Therefore, sufficient attentions should be paid to such the scattering property in preparing the hydrophobic coating film-forming composition according to the present embodiment, and accordingly it is preferable to scatter the hydrophobic fine silica compound, resin compound, and volatile solvent by using a high-speed scattering apparatus. Because the hydrophobic fine silica compound used in the embodiment is ultrafine particles, it is preferable that the hydrophobic coating film-forming composition is made to be excellent in the stability and uniformity by using a homogenizer, colloid mill, ball mill, beads mill, sand mill, three-roll mill, kneader, extruder, or high-speed scattering apparatus, such as ultrasonic scattering apparatus or high-pressure jet mill scattering apparatus.

When the aforementioned hydrophobic coating film-forming composition is coated and dried on the surface of a member to be treated, a film having a so-called fractal structure is efficiently and uniformly formed, the fractal structure having fine concavities and convexities that are water repellent and excellent in hydrophobicity.

### [Substrate]

A substrate to be used in the pressure-sensitive adhesive tape 10 according to the present embodiment is not particularly limited, but can be composed of an appropriate thin-walled body. Examples of such a thin-walled body include, for example: paper substrates, such as paper, etc.; fiber substrates (the materials of which are not particularly limited, but can be appropriately selected from the group of, for example, Manila hemp, rayon, polyester, and pulp fiber, etc.), such as cloth, nonwoven fabric, and net, etc.; metal substrates, such as metallic foil and metal plate, etc.; plastic substrates, such as plastic film and sheet, etc.; rubber substrates, such as rubber sheet, etc.; foams, such as foam sheet, etc.; and laminated bodies thereof (in particular, laminated bodies formed of a plastic substrate and another substrate and those formed of both plastic films (or sheets)), etc.

Examples of the materials of the plastic films and sheets include, for example: olefin resins whose monomer component is an α-olefin, such as polyethylene (PE), polypropylene (PP), ethylene-propylene copolymer, and ethylene-vinyl acetate copolymer (EVA), etc; polyester resins, such as polyethylene terephthalate (PET), polyethylene naphthalate (PEN), polybutylene terephthalate (PBT), etc.; polyvinyl chloride (PVC); vinyl acetate resin; polyphenylene sulfide (PPS); polyamide (nylon); amide resins, such wholly aromatic polyamide (aramid), etc.; polyimide resin; and polyether ether ketone (PEEK), etc. These materials can be used alone or in combination of two or more thereof.

When a plastic substrate is used as the substrate, the deformation performance thereof, such as an elongation percentage, may be controlled by a stretching treatment, etc. Also, when the pressure-sensitive adhesive layer 12 is formed by being cured with an activated energy ray, it is preferable to use a substrate by which the transmission of the activated energy ray is not hampered.

In order to enhance the adhesiveness with the pressure-sensitive adhesive layer 12, the surface of the substrate may be subjected to a commonly-used surface treatment, such as a chemical or physical oxidation treatment, etc., for example, corona treatment, chromic acid treatment, ozone exposure, flame exposure, high-voltage electrical-shock exposure, and ionizing radiation treatment, etc., or to a coating treatment with the use of an undercoat or parting agent.

The thickness of the substrate may be appropriately selected in accordance with the strength, flexibility, and a purpose of use. For example, the thickness thereof is usually smaller than or equal to 1000 μm (for example, 1 to 1000 μm), preferably 1 to 500 μm, and more preferably approximately 3 to 300 μm, but is not limited thereto. In addition, the substrate may have either form of a single layer and laminated layers.

### [Separator]

In the present embodiment, a separator (release liner) may be used to protect the pressure-sensitive adhesive surface of the pressure-sensitive adhesive layer 12 or the pressure-sensitive adhesive tape 10. Alternatively, a separator may not always be used. The separator is peeled off when the pressure-sensitive adhesive surface protected by the separator is to be used (that is, when an adherend is to be attached to the pressure-sensitive adhesive layer 12 protected by the separator).

A commonly-used release paper can be used as such a separator. Specific examples of the separator include, for example: low adhesive substrates consisting of a fluorine polymer (for example, polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer etc.); and low adhesive substrates consisting of a non-polar polymer (for example, olefin resins, such as polyethylene and polypropylene, etc.), etc., as well as the substrates each having a release treatment layer treated by a release treatment agent on at least one surface thereof. In addition, the separator can also be used as a substrate for supporting the pressure-sensitive adhesive layer 12.

As a separator, for example, a separator in which a release treatment layer is formed on at least one surface of the substrate for a release liner can be preferably used. Examples of such a substrate for a release liner include: plastic substrate films (synthetic resin films), such as polyester film (polyethylene terephthalate film, etc.), olefin resin film (polyethylene film or polypropylene film, etc.), polyvinylchloride film, polyimide film, polyamide film (nylon film), and rayon film, etc.; papers (high-quality paper, Japanese paper, craft paper, glassine paper, synthetic paper, top coat paper, etc.); and multilayered substrates formed by laminating or co-extruding these (complex with 2 to 3 layers), etc.

On the other hand, the release treatment agent of which the release treatment layer consists is not particularly limited, but, for example, a silicone release treatment agent, fluorine release treatment agent, and long-chain alkyl release treatment agent, etc., can be used. The release treatment agents can be used alone or in combination of two or more thereof. In addition, the thickness of the separator and a formation method thereof, etc., are not particularly limited.

### [Acrylic Pressure-Sensitive Adhesive Tape]

Of the pressure-sensitive adhesive tapes according to the present embodiment, the pressure-sensitive adhesive tape containing an acrylic polymer in its adhesive composition or substrate is excellent in the initial adhesiveness at low temperature (for example, at temperature within a range of approximately −20 to 5° C.) Also, the pressure-sensitive adhesive tape containing bubbles in its pressure-sensitive adhesive layer or substrate exhibits high resistance to resilience by improving the stress relaxation property. Also, because the pressure-sensitive adhesive tape can easily follow a curved surface, a concave-convex surface, and a bend of an adherend, an area enough for adhesion can be secured. Also, because the pressure-sensitive adhesive tape is excellent in the stress dispersibility, high shear force can be obtained. Also, because the pressure-sensitive adhesive tape has the pressure-sensitive adhesive layer 12 moderately containing the hollow inorganic fine particles, excellent adhesive force at normal temperature and shear adhesive force can be obtained.

The acrylic pressure-sensitive adhesive tape is excellent in the initial adhesiveness to the adherends that hardly adhere to others, such as: coating films (for example, acid-rain resistant coating film and automotive coating film, etc.); metal plates, such as painted plate, resin plate, and steel plate, etc.; and coated plates (for example, a coated plat in which a coating film, such as the aforementioned acid-rain resistant coating film or automotive coating film, etc., is coated on the surface of a metal plate, such as the aforementioned resin plate or steel plate, etc.), etc. In particular, the acrylic pressure-sensitive adhesive tape is excellent in the initial adhesiveness to an automotive coated plate, such as automobile body, etc.

A coating film that is an adherend is not particularly limited, and examples thereof include various coating films including, for example, polyester melamine coating film, alkyd melamine coating film, acrylic melamine coating film, acrylic urethane coating film, and acrylic-polyacid curing agent, etc.

In particular, a water-repellent layer is formed on the pressure-sensitive adhesive surface of the pressure-sensitive adhesive layer 12 in the pressure-sensitive adhesive tape according to the present embodiment, and hence it can be reduced the adhesive force may be decreased due to the retention of water on the pressure-sensitive adhesive surface or the entry of water into the pressure-sensitive adhesive layer even when the pressure-sensitive adhesive tape is used in the environment with high humidity or applied to an adherend with water droplets thereon. Also, as a result of the intensive study by the present inventor, it has been found that the peel-off adhesive strength occurring immediately after the pressure-sensitive adhesive tape has been attached to an adherend can be reduced because a water-repellent layer is formed on the pressure-sensitive adhesive surface of the pressure-sensitive adhesive layer 12 with the aforementioned water repellent. Thereby, the attachment position can be easily corrected even after the pressure-sensitive adhesive tape has been once attached.

Accordingly, the pressure-sensitive adhesive tape 10 according to the present embodiment can be preferably used in the casings of large, flat television sets, electrical home appliances, and household equipment, etc., and in the components contained therein besides the aforementioned applications. In these applications, because the position of the attached pressure-sensitive adhesive tape can be corrected relatively easily, the work efficiency can be improved and occurrence of a defective product, due to the mistake of attaching the pressure-sensitive adhesive tape, can also be reduced.

In addition, the adhesive strength of the pressure-sensitive adhesive tape 10 according to the present embodiment is gradually increased with a lapse of time after the pressure-sensitive adhesive tape 10 was attached to an adherend. The pressure-sensitive adhesive tape 10 finally exhibits the same adhesive strength as that occurring when a pressure-sensitive adhesive layer not having the water-repellent layer is peeled off from an adherend. According to the pressure-sensitive adhesive tape 10 of the present embodiment, the workability in attaching the pressure-sensitive adhesive tape and the adhesion reliability can be compatible, as stated above.

### [Outline of Manufacturing Method]

The adhesive composition 16 according to the present embodiment is coated on a predetermined surface and cured with photopolymerization by radiating an ultraviolet ray to form the pressure-sensitive adhesive layer 12. The pressure-sensitive adhesive layer 12 made to be adhesive has pressure-sensitive adhesiveness itself. Thereafter, the water-repellent layer is formed on the pressure-sensitive adhesive surface of the pressure-sensitive adhesive layer 12 by using the aforementioned water repellent and the later-described method. A radiation amount of an ultraviolet ray in the photopolymerization is within a range of approximately 200 to 3000 mJ/cm². In this case, the thickness of the adhesive composition 16 is arbitrary as far as the thickness thereof is greater than or equal to the particle size of the hollow inorganic fine particle 18; however, it is preferable to be approximately 100 to 3000 μm. Examples of a method of forming a water repellent on a pressure-sensitive adhesive surface include a method in which a water repellent is directly coated on a pressure-sensitive adhesive surface and cured to form a water-repellent layer, and a method in which a film produced by once coating and drying a water repellent on another substrate is transferred onto a pressure-sensitive adhesive surface to form a water-repellent layer, etc.

When coating the adhesive composition 16 on a substrate, etc., it is preferable to increase the viscosity of the adhesive composition 16 in order to smoothly perform the work. An increase in the viscosity thereof can be adjusted by, for example: a method of combining various polymer components, such as acrylic rubber, and thickening additive, etc.; and a method of partially polymerizing a monomer component for forming a base polymer [for example, a monomer component for forming an acrylic polymer, such as (meth)acrylic acid ester, etc.], etc.

### EXAMPLES

Hereinafter, the present invention will be described in detail based on Examples, but the invention should not be limited at all by these Examples.

### Example 1

A diluted solution in which a super water-repellent: “ADESSO WR-1” (made by NICCA CHEMICAL CO., LTD.) is diluted in a concentration of 1.5% was coated on a polyethylene terephthalate film: “Lumirror S10#38” (made by TORAY INDUSTRIES, INC.) having a thickness of 38 μm by using Meyer Bar #5, and was dried under room temperature to form a coating film. The contact angle with water on the surface of the PET film on which the “ADESSO WR-1” had been coated as stated above was 149°. Thereafter, the polyethylene terephthalate was attached, with a hand roller, to the pressure-sensitive adhesive surface of a pressure-sensitive adhesive tape: “HYPERJOINT H9004” (made by NITTO DENKO CORPORATION), which is a pressure-sensitive adhesive tape with an acrylic adhesive thereon, so that the coating film faced the pressure-sensitive adhesive surface. Thereby, the coating film was transferred onto the pressure-sensitive adhesive surface of the pressure-sensitive adhesive layer to obtain a double-faced pressure-sensitive adhesive tape, on the surface of which a water-repellent layer was formed.

After a polyethylene terephthalate film: “Lumirror S10#50” (made by TORAY INDUSTRIES, INC.) having a thickness of 50 μm was attached to the pressure-sensitive adhesive surface of the both-faced pressure-sensitive adhesive tape, on the pressure-sensitive adhesive surface a water-repellent layer not being formed, the pressure-sensitive adhesive tape 10 was cut to have a width of 10 mm. Subsequently, the surface on the water-repellent side of the cut pressure-sensitive adhesive tape was press-attached, by reciprocating a 2-kg roller once, to a polycarbonate plate (made by TAKIRON Co., LTD.) whose surface had been cleaned with alcohol. The resultant object was used as an evaluation sample.

### Comparative Example 1

After the “Lumirror S10#50” was attached to the pressure-sensitive adhesive surface of the “HYPERJOINT H9004”, a pressure-sensitive adhesive tape, the pressure-sensitive adhesive tape was cut to have a width of 10 mm. Subsequently, the cut pressure-sensitive adhesive tape was press-attached to the polycarbonate plate in the same way as in Example 1, which was used as an evaluation sample.

### (Contents of Evaluation)

Evaluation was made based on a change over time in the adhesive strength occurring when a sample was peeled off at a peel-off angle of 90°. The evaluation samples shown in Example 1 and Comparative Example 1 were left in an environment at 23° C. and press-attached. After lapses of time of ten seconds, 30 minutes, two days, and five days after the press-attachment, the 90° peel-off adhesive strength was measured with a tensile and compression testing machine: “TG-1kN” (made by Minebea Co., Ltd.) by peeling off a sample at tension speed of 50 mm/min and in a peel-off direction of 90°. The measurement results are shown in Table 1.

TABLE 1

| | | | DIFFERENCE |
|---|---|---|---|
| | ADHESIVE STRENGTH | | BETWEEN |
| | [N/10 mm] | | EXAMPLE 1 AND |
| LAPSE OF | | COMPARATIVE | COMPARATIVE |
| TIME | EXAMPLE 1 | EXAMPLE 1 | EXAMPLE 1 |
| 10 SECONDS | 5.8 | 8.9 | 3.1 |
| 30 MINUTES | 7.0 | 9.5 | 2.5 |
| 2 DAYS | 9.8 | 10.8 | 1.0 |
| 5 DAYS | 10.3 | 10.7 | 0.4 |

As shown in Table 1, the pressure-sensitive adhesive tape shown in Example 1 in which the water-repellent layer is formed has lower adhesive strength after lapses of time of ten seconds and 30 minutes after the press-attachment, than those of the pressure-sensitive adhesive tape in Comparative Example 1. That is, even when such a pressure-sensitive adhesive tape is attached to an adherend, the attachment position can be easily corrected even after the pressure-sensitive adhesive tape has been once attached to the adherend because the peel-off adhesive strength is small immediately after the attachment. Also, the adhesive strength of the pressure-sensitive adhesive tape described in Example 1 is increased with a lapse of time, and the same adhesive strength as that of Comparative Example 1 not having a water-repellent layer can be obtained five days later. As a result, the adhesion reliability in the parts in which the pressure-sensitive adhesive tape is used is improved.

The present invention has been described above based on the embodiments and examples. The embodiments are described for exemplary purposes only, and it can be readily understood by those skilled in the art that various modifications may be made by making various combinations of the aforementioned components or processes, which are also encompassed in the scope of the present invention.

Hereinafter, variations of a water repellent and various components contained in the water repellent, which are applicable in the present invention, will be described. For example, a water repellent in which fine particles of low-molecular polytetrafluoroethylene (PTFE) are scattered, as hydrophobic fine particles, in a hydrophobic binder resin, such as acrylic silicone resin, etc., may be used. Specifically, a water repellent in which low-molecular tetrafluoroethylene powder, which has a molecule weight of 500 to 20000 and is fluorinated up to the terminal thereof, is mixed and scattered in at least one resin selected from the group of an acrylic silicone resin, polyester resin, epoxy resin, acrylic resin, urethane resin, and fluorine resin, or in a mixed resin thereof, in an amount of 1 to 70 volume % as a volume fraction after volatile components have been volatilized, may be used. Such a water repellent exhibits the water repellency in which a contact angle with water is greater than or equal to approximately 160°.

In addition, examples of the hydrophobic fine particles include, besides the aforementioned silica, a single body or compound of inorganic materials, such as various kinds of glass including SiO₂, shirasu, silica sand, zeolite, and silicon carbide (SiC), etc., and a single body or compound of organic materials, such as cross-linked poly methyl methacrylate and urethane, etc. A compound of these inorganic materials and organic materials may also be used. As a mixing ratio of these fine particles, it is preferable to mix and scatter these fine particles in an amount of 10 to 90% as a weight fraction after a solvent has been volatilized.

Examples of a coupling agent include a single body or compound of a silane coupling agent and titanium coupling agent each having a water-repellent group in its molecule. It is preferable to mix and scatter the coupling agent in an amount of 1 to 50 mass %.

Silane coupling is usually represented by YRSiX₃; however, a silane coupling agent in which the portion represented by Y is fluorinated and the portion represented by R is short is preferred in terms of the water repellency.

The hydrophobic fine particles may also be hard fine particles subjected to a surface treatment by a hydrophobic silane coupling agent excluding fluorine. Examples of the hydrophobic silane coupling agent include RSiX₃, R₂SiX₂ and R₃SiX, wherein R represents an alkyl group, such as methyl group, ethyl group, propyl group, isopropyl group, butyl group, isobutyl group, or tertiary-butyl group, etc.; and X represents an alkoxy group, such as methoxy group, ethoxy group, or β-methoxyethoxy group, etc., or a halogen substituent, such as chlorine, etc. These coupling agents are cheaper than the silane coupling agents including fluorine by one order or so.

What is claimed is:

1. A pressure-sensitive adhesive tape comprising:
a pressure-sensitive adhesive layer; and
a water-repellent layer formed on the pressure-sensitive adhesive surface of the pressure-sensitive adhesive layer, wherein the water-repellent layer is formed by using a water repellent exhibiting the water repellency in which a contact angle with water is greater than or equal to 140°.

2. The pressure-sensitive adhesive tape according to claim 1, wherein the water-repellent layer has hydrophobic fine particle.

3. The pressure-sensitive adhesive tape according to claim 2, wherein the hydrophobic fine particle contains a hydrophobic fine silica compound.

4. The pressure-sensitive adhesive tape according to claim 3, wherein the hydrophobic fine silica compound is modified with hexamethyldisilazane.

5. The pressure-sensitive adhesive tape according to claim 1, wherein the pressure-sensitive adhesive layer contains an acrylic polymer whose monomer main component is (meth)acrylic acid alkyl ester.

6. The pressure-sensitive adhesive tape according to claim 2, wherein the pressure-sensitive adhesive layer contains an acrylic polymer whose monomer main component is (meth)acrylic acid alkyl ester.

7. The pressure-sensitive adhesive tape according to claim 3, wherein the pressure-sensitive adhesive layer contains an acrylic polymer whose monomer main component is (meth)acrylic acid alkyl ester.

8. The pressure-sensitive adhesive tape according to claim 4, wherein the pressure-sensitive adhesive layer contains an acrylic polymer whose monomer main component is (meth)acrylic acid alkyl ester.

9. A method of manufacturing a pressure-sensitive adhesive tape, comprising:
preparing a pressure-sensitive adhesive layer; and
forming a water-repellent layer on the pressure-sensitive adhesive surface of the pressure-sensitive adhesive layer by using a water repellent exhibiting the water repellency in which a contact angle with water is greater than or equal to 140°.

10. The method of manufacturing a pressure-sensitive adhesive tape according to claim 9, wherein the water repellent has hydrophobic fine particle.

11. The method of manufacturing a pressure-sensitive adhesive tape according to claim 10, wherein the hydrophobic fine particle contains a hydrophobic fine silica compound.

12. The method of manufacturing a pressure-sensitive adhesive tape according to claim 11, wherein the hydrophobic fine silica compound is modified with hexamethyldisilazane.
